(19) United States
(12) Patent Application Publication
(10) Pub. No.: US 2026/0175887 A1
(43) Pub. Date: Jun. 25, 2026

(54) COLLAPSIBLE CART

(71) Applicant: Guoju Zhang, Ningbo (CN)

(72) Inventor: Guoju Zhang, Ningbo (CN)

(21) Appl. No.: 19/002,006

(22) Filed: Dec. 26, 2024

(30) Foreign Application Priority Data
Dec. 19, 2024 (CN) 2024118859155
Dec. 19, 2024 (CN) 2024231525734

(51) Int. Cl. B62B 3/02; B62B 3/00

(52) U.S. Cl. CPC B62B 3/02; B62B 3/002; B62B 2205/20

(57) ABSTRACT

A collapsible cart having rigid frame side walls in a hinged arrangement to allow the side walls to collapse is presented. Each sidewall includes a rotatable lever to lock or unlock the side wall, with the unlocked position configured to allow the sidewall to fold inwardly and the locked position to restrict inward movement of the panels of the sidewall.

### CROSS-REFERENCE TO RELATED APPLICATIONS

This application claims is based on and claims the benefit of priority from Chinese Patent Application No. CN2024118859155, filed on Dec. 19, 2024, and Chinese Patent Application No. CN2024231525734, filed on Dec. 19, 2024, the content of each is incorporated herein by reference.

### BACKGROUND OF THE INVENTION

Collapsible carts are a widely used tool in household and commercial settings. They provide a convenient way to transport objects when needed, but can be folded or collapsed for storage.

The following patents and published applications are representative prior art: U.S. Pat. No. 2,564,939, issued to Louis S. Weast on Aug. 21, 1951 entitled Foldable Shopping Cart; U.S. Pat. No. 3,092,395 issued to Mitty et al. on Jun. 4, 1963 entitled Corrugated Shopping Cart and Parts; U.S. Pat. No. 3,135,527 issued to Philip B. Knapp on Jun. 2, 1964 entitled Wheeled Market Carts; U.S. Pat. No. D292,135 issued to John W. Grube et al. on Sep. 29, 1987 entitled Collapsible Cart; U.S. Pat. No. 4,765,646 issued to Karen Cheng on Aug. 23, 1988 entitled Collapsible Shopping Cart;

United States Published Patent Application No. 2009/0212536 to Maria I. Tadeo on Aug. 27, 2009 entitled Collapsible Rolling Tote Bag; U.S. Pat. No. 7,731,221 issued to Suzan L. Bess on Jun. 8, 2010 entitled Collapsible and Portable Wheeled Dolly Particularly Suitable for Use by Students or Others in the Transport of Items; U.S. Pat. No. 7,066,476 issued to Elden on Jun. 27, 2006 entitled Side Attachable Cover/Seat for a Cart Carrying Box; U.S. Pat. No. 8,439,374 issued to Elden on May 14, 2013 entitled Lightweight High Load Capacity Folding Utility Cart with Unique Support Structure and Ergonomic Handle; and U.S. Pat. No. 11,338,835 issued to Elden on May 24, 2022 entitled High Load Capacity Collapsible Carts.

Because of the collapsible nature of the prior art cart design, the sidewalls may not be sufficiently sturdy to allow for transporting heavy objects, so there is a need in the art for a collapsible cart with rigid sidewalls that can move from a locked to unlocked and collapsible position. Some solutions in the art have provided flexible walls that can move from rigid to flexible positions, but the locking solutions for the rigid positions have not effectively addressed this problem.

In particular, U.S. Pat. No. 11,338,835 issued to Elden entitled High Load Capacity Collapsible Carts teaches a collapsible cart with sidewalls having a fastening mechanism, such as slideable members cooperatively engaging tracks or fastening connectors, and are movable between an open position to allow the sidewall to fold inwardly, to a closed position to selectively lock the panels of the sidewall. However, as shown and taught by Elden, the locking mechanism is a slidable member that engages on the outside of the sidewall in a track and may, as a result, may removed, losing the locking mechanism. Thus, the need for improvements to collapsible carts still remains.

### SUMMARY OF THE INVENTION

In general, the collapsible cart of the present invention may include a rigid frame forming a compartment, with the frame having a front wall, a rear wall, a right sidewall, a left sidewall, and a bottom wall. The right and left sidewall each include a first panel and a second panel. The panels for the sidewalls are in a hinged relationship, with the first panel coupled to the second panel along a vertical axis.

The top surface of the frame has a top edge providing a lip along each of the walls and sidewalls. A locking mechanism is embedded in the lip of each of the right and left sidewall to allow selective engagement of the sidewalls to a locked position. In particular, a locking arm is pivotally engaged in the interior of the lip of the first panel of both the right and left side panel and configured to move from a first unlocked position to a second locked position in the interior of the lip of the second panel.

In another embodiment, a locking mechanism is embedded in either the left or right side wall to allow selective engagement of the sidewalls to a locked position. In particular, a locking arm is pivotally engaged in the interior of the lip of the first panel of both the right and left side panel and configured to move from a first unlocked position to a second locked position in the interior of the lip of the second panel.

### BRIEF DESCRIPTION OF DRAWINGS

FIG. 1 is a front perspective view of the collapsible cart in an expanded configuration;

FIG. 2 is a left side view of the same, the right side being a mirror image thereof;

FIG. 3 is a front side view of the same;

FIG. 4 is a bottom view of the same;

FIG. 5 is a top view of the same;

FIG. 6 is a side perspective view showing area A;

FIG. 7 is a close-up view of area A indicated in FIG. 6;

FIG. 8 is a side perspective view showing area B;

FIG. 9 is a close-up view of area B indicated in FIG. 8;

FIG. 10 is a side perspective view of the collapsible cart in a semi-collapsed configuration;

FIG. 11 is a front perspective of the collapsible cart in a collapsed configuration.

### DETAILED DESCRIPTION OF THE INVENTION

Before the present invention is described in further detail, it should be understood that the invention is not limited to the particular embodiments described, and that the terms used in describing the particular embodiments are for the purpose of describing those particular embodiments only, and are not intended to be limiting, since the scope of the present invention will be limited only by the claims.

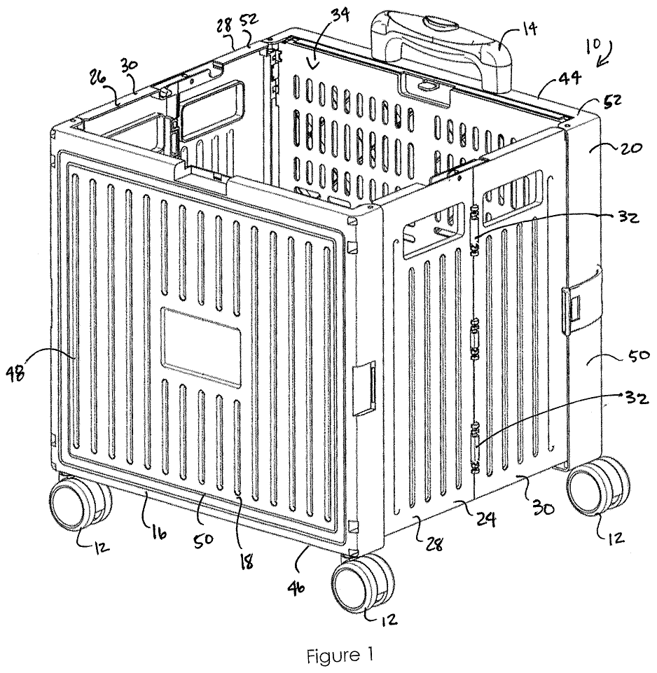

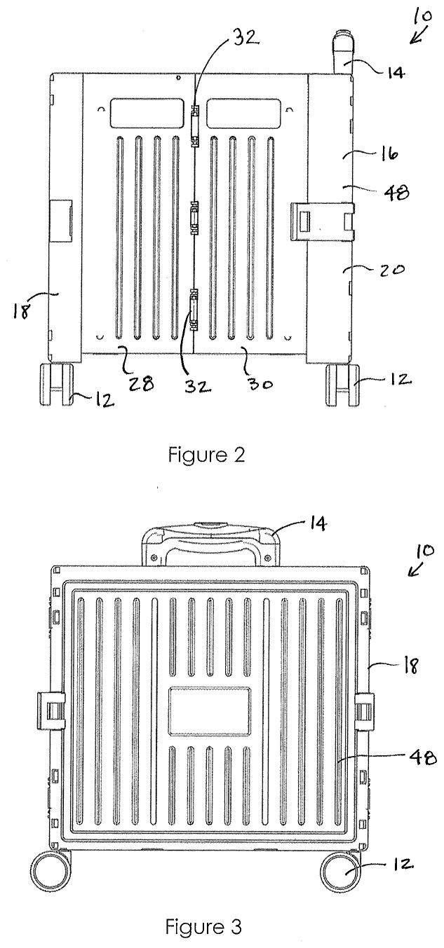

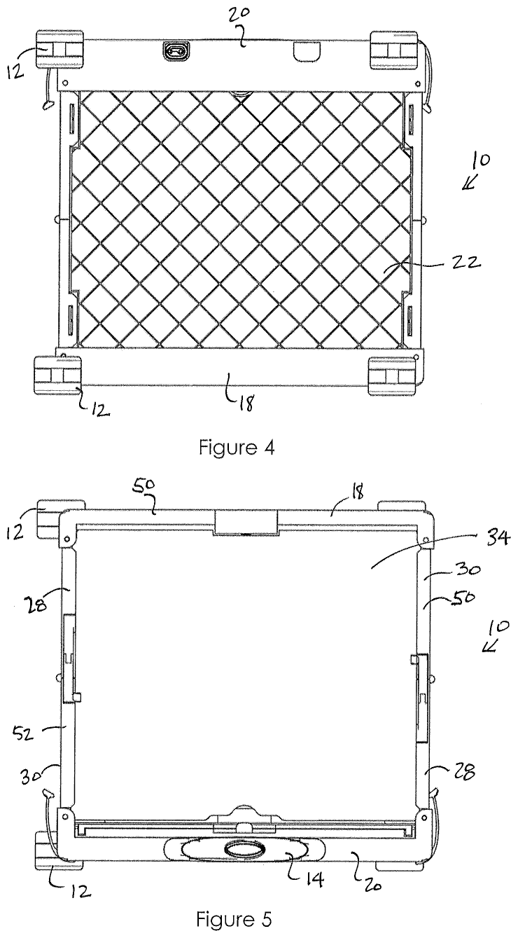

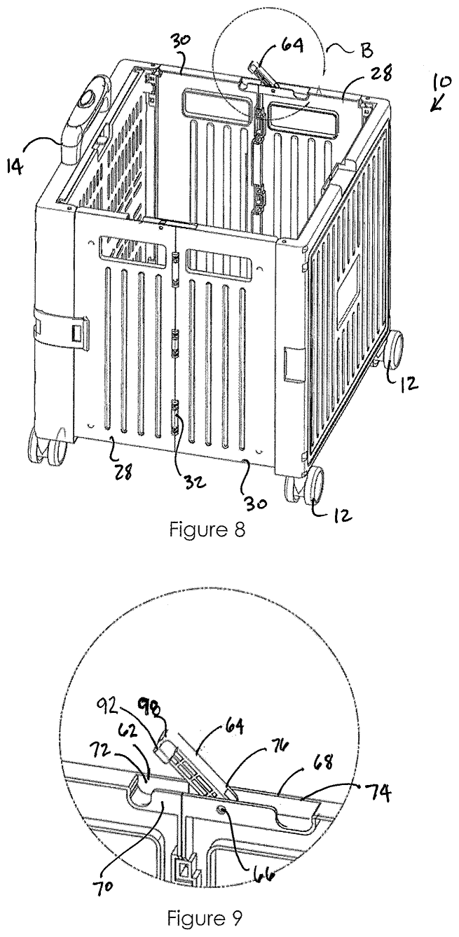

Generally speaking, as shown in FIGS. 1-11 , the present invention is directed to a collapsible cart 10 having wheels 12, a telescoping handle 14, and a frame 16. In general, the frame 16 is composed of a front wall 18, a rear wall 20, a removable base 22, and a right and left opposing side walls 24, 26. Both the right side wall 24 and the left side wall 26 are separately composed of a first panel 28 and a second panel 30 and joined in a hingeable relationship by at least one hinge 32.

The frame 16 walls forming the exterior sides 50 of the cart 10—the front wall 18, the rear wall 20, and the right and left opposing walls 24, 26 extend a length from the top 44 of the cart 10 to the base 46 of the cart 10. The exterior walls 50 additionally extend inwardly from the exterior surface 48 of the cart a distance and provide an upper edge 52 for top of the exterior sides 50 of the cart.

As shown in FIGS. 1-11 , the collapsible cart 10 may include a plurality of rotatable wheels 12 coupled to the front and rear walls 18, 20 at the base 46 of the walls of the collapsible cart 10. The rotatable wheels 12 may include at least one wheel locking assembly to prevent rolling movement.

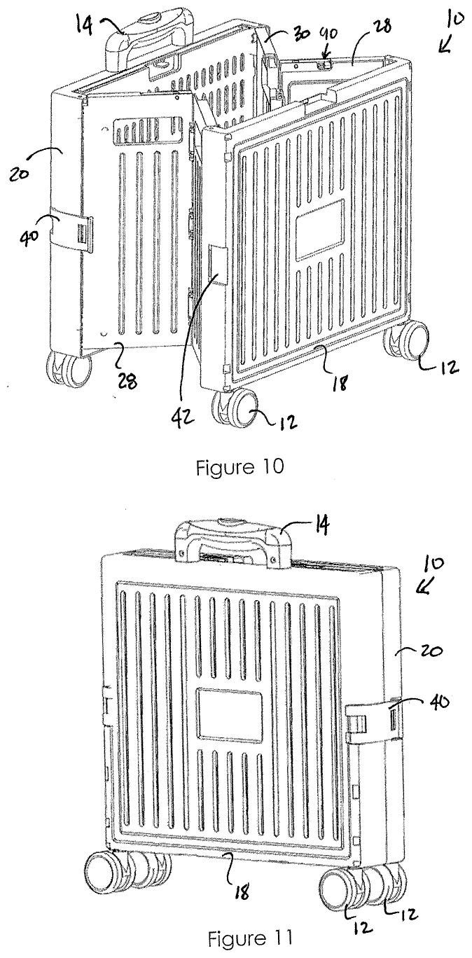

The collapsible cart, as shown in FIGS. 1-9 , has an expanded, uncollapsed configuration, and, as shown in FIGS. 10-11 , a condensed, collapsed configuration. In the expanded and uncollapsed configuration, the frame 16 walls—front wall 18, a rear wall 20, a removable base 22, and a right and left opposing side walls 24, 26—form a compartment 34. In one embodiment, the removable base 22 is in a pivotal relationship with the front or rear wall, 18, 20. In another embodiment, the removable base 22 is configured to be removed by the user of the cart 10 before the cart is collapsed.

As shown in FIGS. 10-11 , the right and left side walls 24,26 are configured to fold inwardly at the hinge 32 to move the cart from the uncollapsed configuration to the collapsed configuration. As shown, the right side wall 24 has a first panel 28 and a second panel 30 coupled or joined to each other by a hinge 32 along a first vertical axis. The first panel 28 and the second panel 30 may be joined by one or more hinges 32. As shown, the left side wall 26 has a first panel 28 and a second panel 30 coupled or joined to each other by a hinge 32 along a first vertical axis. The first panel 28 and the second panel 30 may be joined by one or more hinges 32.

As shown in the figures, a locking mechanism 60 is configured to retain the uncollapsed configuration and provide a rigid structure to the side walls. The locking mechanism 60 may be on the right side wall 24 or the left side wall 26 or both 24,26. The locking mechanism 55 is composed of a locking channel 62, located along the upper edge 52 and extending along a portion of the first panel 28 and second panel 30 of the right and left side wall 24, 26 at the top of the vertical axis of the hinge 32, a locking lever 64 and a locking pin 66. The locking channel 62 is formed in and positioned in the wall of the first panel 28 and second panel 30 with a first channel wall 68 of the channel 62 proximate the exterior wall 48 of the cart 10 and a second channel wall 70 proximate the interior of the cart 10. The first channel wall 68 is opposite the second channel wall and form together a compartment within the first panel 28 and second panel 30 for the locking lever 64.

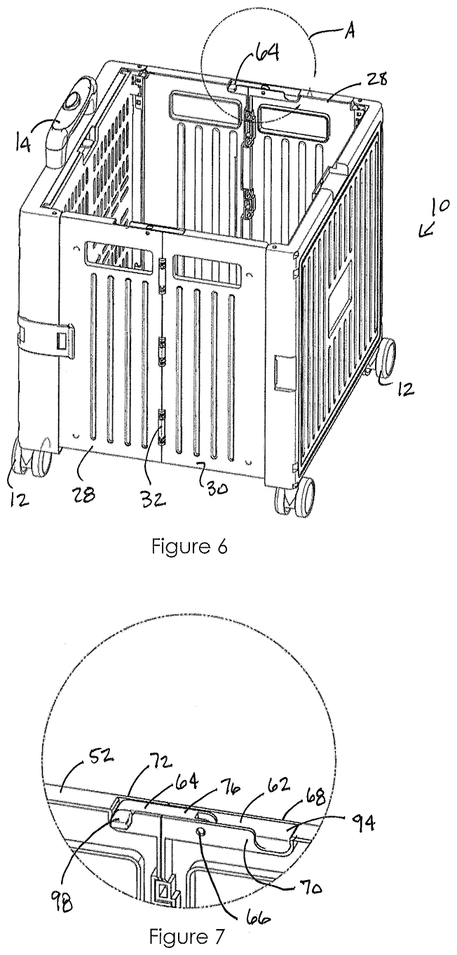

As shown in FIGS. 6-9 , the locking lever 64 is an elongated arm having a first end 98 having an engaging portion 92 and a second end 76 pivotally connected to the locking pin 66 and secured within the locking channel 62. The locking lever 64 is retained within the locking channel 62 with the first channel wall 68 and the second channel wall 70 providing a reinforcement and support for the locking lever 64 when it is in the locked position. As shown in FIGS. 6-7 , the locking lever 64 in the locked position is located on a first side 72 of the locking channel 62, with the locking lever 64 extending from the second end 76 of the locking lever above the first panel 28 of the side wall to the first end 98 of the locking lever 64 above the second panel 30. In this manner, the locking lever 64 within the locking channel above the hinge 32 restricts movement of the first panel 28 and second panel 30 inwardly at the hinge 32. Once the lever 64 is pivotally motivated, the lever 64 moves to a second side 74 of the locking channel 62 to an unlocked position 90 (FIG. 10) with the locking lever 64 located above only the first panel 28 of the side wall.

Once the locking lever is in an unlocked position 90, the left and right side walls 24, 26 can fold inwardly along the hinge 32 to collapse the cart. Once the cart is in the collapsed configuration as shown in FIGS. 10-11, a locking arm 40 connected to the rear wall 20 can engage with a locking port 42 on the front wall 18. In another embodiment, a locking arm 40 connected to the front wall 18 can engage with a locking port 42 on the rear wall 20. In this manner, the cart 20 can be locked to retain the collapsed configuration.

All terms used herein should be interpreted in the broadest possible manner consistent with the context. When a grouping is used herein, all individual members of the group and all combinations and subcombinations possible of the group are intended to be individually included. When a range is stated herein, the range is intended to include all subranges and individual points within the range. All references cited herein are hereby incorporated by reference to the extent that there is no inconsistency with the disclosure of this specification.

The present invention has been described with reference to certain preferred and alternative embodiments that are intended to be exemplary only and not limiting to the full scope of the present invention, as set forth in the appended claims.

1. A collapsible cart comprising:
a frame forming a compartment, said frame including at least two opposing side walls, each opposing side wall of said at least two opposing side walls comprising a first panel and a second panel joined by at least one hinge;
a locking channel formed in and extending a length across said first and said second panel, said locking channel having a first channel wall proximate said compartment and a second channel wall opposite said first channel wall;
a locking lever having a first end secured in said locking channel and configured to move from a locked position in said locking channel extending across said first panel and said second panel to an unlocked position in said locking channel above said first panel;
said at least two opposing side walls configured to fold inwardly.

2. The collapsible cart of claim 1 further comprising a locking pin securing said first end of said locking lever in said locking channel.

3. The locking lever of claim 1 further comprising a second end having an engaging portion.

4. A collapsible cart comprising:
a frame forming a compartment, said frame including at least two opposing side walls, at least one side wall of said at least two opposing side walls comprising a first panel and a second panel joined by at least one hinge;
a locking channel formed in and extending a length across said first and said second panel, said locking channel having a first channel wall proximate said compartment and a second channel wall opposite said first channel wall;
a locking lever having a first end secured in said locking channel and configured to move from a locked position in said locking channel extending across said first panel and said second panel to an unlocked position in said locking channel above said first panel;
said at least two opposing side walls configured to fold inwardly.

5. The collapsible cart of claim 4 further comprising a locking pin securing said first end of said locking lever in said locking channel.

6. The locking lever of claim 4 further comprising a second end having an engaging portion.

7. A sidewall for a collapsible cart, said sidewall comprising:
a first panel;
a second panel;
at least one hinge joining said first panel to said second panel in a hinged relationship;
a locking channel formed in and extending a length across said first and said second panel above said at least one hinge, said locking channel having a first channel wall and a second channel wall opposite said first channel wall defining said locking channel; and
a locking lever having a first end secured pivotally in said locking channel and configured to move from a locked position in said locking channel extending across said first panel and said second panel to an unlocked position in said locking channel above said first panel.

8. The side wall of claim 7 further comprising a locking pin securing said first end of said locking lever in said locking channel.

9. The side wall of claim 7 further comprising a second end having an engaging portion.
